(19) United States
(12) Patent Application Publication
(10) Pub. No.: US 2026/0099880 A1
(43) Pub. Date: Apr. 9, 2026

(54) MULTI-CURRENCY VALIDATION GAMING SYSTEM AND METHOD FOR USING THE SAME

(71) Applicant: JCM American Corporation, Las Vegas, NV (US)

(72) Inventors: Mike Nguyen, Las Vegas, NV (US); David C. Kubajak, Las Vegas, NV (US)

(21) Appl. No.: 18/959,461

(22) Filed: Nov. 25, 2024

Related U.S. Application Data
(60) Provisional application No. 63/703,931, filed on Oct. 5, 2024.

(51) Int. Cl. G06Q 40/04; G07D 7/00; G07F 17/32

(52) U.S. Cl. CPC G06Q 40/04; G07D 7/00; G07F 17/32

(57) ABSTRACT

A multicurrency validation system and method for legacy electronic gaming machines utilizing a smart bill validator, peripheral network adapter, peripheral management system and 3^{rd} party system (e.g., TITO system). With such a system the electronic gaming machine software need not be modified and can work with any system with access to a TITO system with eligible secondary currencies being converted to a TITO validation number and processed as a virtual TITO ticket. Certain configurations allow the use of AFT and EFT payments directly to the EGM.

### CROSS-REFERENCE

This application claims priority to U.S. Patent Application No. 63/703,931 filed Oct. 5, 2024 and which is incorporated herein for all purposes.

### FIELD OF THE INVENTION

The embodiments of the present invention relate to multicurrency validation system on legacy electronic gaming machines (EGM) using a smart bill validator connected to a peripheral management system. With such a system, the EGM's software does not need to be modified, and the multicurrency validation system operates with any casino system having access to a casino's ticket-in ticket-out (TITO) system or other suitable 3^{rd} party system.

### BACKGROUND

As gaming has proliferated worldwide, the ability to accept different currencies has become a desired feature. However, reconfiguring 100 s or 1000 s of EGMs to accept different currencies is labor intensive and time consuming.

It would be advantageous for casinos to be able to modify large numbers of installed EGMs to accept multiple currencies without having to modify the software of the EGMs in any way, including software associated with smart bill validators.

### SUMMARY

The embodiments disclosed herein involve a network of EGMs having smart bill validators in communication with a peripheral network adapter (PNA) running peripheral management software. The PNA is further in communication with a 3^{rd} party TITO-type system.

In one embodiment, PNAs are installed inside EGMs on the casino floor. The PNAs are further communicatively connected to a Mobile I/O and casino network to report to the peripheral management software (e.g., FUZION® manufactured and sold by Applicant). The PNAs display as EGM assets within the peripheral management software.

In one embodiment, the peripheral management software is installed within the casino network and runs on one or more servers.

In one embodiment, the EGMs use smart bill validators (e.g., iVIZION® manufactured and sold by Applicant).

In one embodiment, a 3^{rd} party system is a TITO system configured to create, validate, and redeem a TITO validation number.

Other variations, embodiments and features of the present invention will become evident from the following detailed description, drawings and claims.

### BRIEF DESCRIPTION OF THE DRAWINGS

The disclosure will be readily understood by the following detailed description in conjunction with the accompanying drawings, wherein like reference numerals designate like structural elements.

FIG. 1 is a block diagram of a casino system according to the embodiments of the present invention.

FIG. 2 is a sequence diagram illustrating a prior art workflow of accepting primary currency supported by the bill validator.

FIG. 3 is a sequence diagram illustrating multicurrency workflow where the PNA validates the secondary currency according to the embodiments of the present invention.

FIG. 4 is a sequence diagram illustrating multicurrency workflow where the PNA validates a currency, and the 3^{rd} party system directly adds credit to an EGM by utilizing AFT, EFT, or a player tracking system according to the embodiments of the present invention.

FIG. 5 is a sequence diagram illustrating multicurrency workflow where the 3^{rd} party system exchanges/converts the currency to a virtual TITO ticket or transfers directly to the EGM using AFT, EFT, or a player tracking system according to the embodiments of the present invention.

FIG. 6 is a sequence diagram illustrating multicurrency workflow where the 3^{rd} party system issues a peripheral management system print command to a specific EGM at any time according to the embodiments of the present invention.

FIG. 7 is an exemplary currency exchange voucher according to the embodiments of the present invention.

FIG. 8 is a first exemplary residual credit voucher according to the embodiments of the present invention.

FIG. 9 is a second exemplary residual credit voucher according to the embodiments of the present invention.

FIG. 10 is a sequence diagram illustrating multicurrency workflow where the residual credit voucher is printed using a separate call to the peripheral management system according to the embodiments of the present invention.

FIG. 11 is a sequence diagram illustrating multicurrency workflow where credits are added to the EGM and the residual credit voucher is printed using a single call to the peripheral management system according to the embodiments of the present invention.

FIG. 12 is a sequence diagram illustrating multicurrency workflow where the 3^{rd} party system issues a promotional coupon for a free drink, free meal, free game play, etc., when a player meets certain criteria according to the embodiments of the present invention.

FIG. 13 is a first exemplary promotional ticket according to the embodiments of the present invention.

FIG. 14 is a second exemplary promotional ticket according to the embodiments of the present invention.

FIG. 15 is a sequence diagram illustrating multicurrency workflow where player acceptance of the exchange rate and fee on the EGM's display causes the 3^{rd} party system to move forward to the next step of creating a virtual TITO validation number or directly adding credit to an EGM using AFT, EFT, or a player tracking system according to the embodiments of the present invention.

FIG. 16 is a sequence diagram illustrating multicurrency workflow where player rejects the exchange rate/fee on the EGM's display causing the 3^{rd} party system to instruct the peripheral management system to reject/return the banknote back to the player according to the embodiments of the present invention.

FIG. 17 is a sequence diagram illustrating multicurrency workflow where the PNA is unable to validate the secondary currency and instructing the bill validator to reject the note according to the embodiments of the present invention.

FIG. 18 is a sequence diagram illustrating multicurrency workflow where the 3^{rd} party system is unable to create a TITO validation number or complete an exchange, or a secondary currency transaction is disabled multicurrency workflow.

FIG. 19 is a sequence diagram illustrating multicurrency workflow where the 3^{rd} party system is offline or not connected to the peripheral management system according to the embodiments of the present invention.

Additionally, it should be understood that the proportions and dimensions (either relative or absolute) of the various features and elements (and collections and groupings thereof) and the boundaries, separations, and positional relationships presented therebetween, are provided in the accompanying Figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wired, wireless, wireline, optical fiber cable, RF, Bluetooth and the like, or any suitable combination of the foregoing. Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or sequence diagrams of methods, apparatus (systems) and computer program products according to embodiments of the invention. It will be understood that each sequence of the flowchart illustrations and/or sequence diagrams, and combinations of sequences in the flowchart illustrations and/or sequence diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or sequence diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or sequence diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or sequence diagrams. As used herein, a “gaming machine” should be understood to be any one of a general purpose computer, as for example a personal computer, laptop computer, standalone machine, a client computer configured for interaction with a server, a special purpose computer such as a server, or a smart phone, soft phone, tablet computer, personal digital assistant or any other machine adapted for executing programmable instructions in accordance with the description thereof set forth above.

Those skilled in the art will recognize that certain types of EGMs, generally utilized in regulated casino environments, are still commonly referred to as “slot machines”. Although the etymology of the term “slot machine” was originally derived from a coin slot in the gaming machines at the time, coin slots have long since generally been replaced by payment input devices or bill validators which only accept paper currency or ticket-in-ticket-out vouchers and/or electronic fund transfer means, such as card readers, mobile device payment means or account interfaces. As a result, the term EGM and slot machine are used interchangeably and are defined to mean something different than a laptop or desktop computer, cell phones, tablet computer gaming devices and the like.

Examples of user personal mobile electronic devices include cell phones, personal digital assistants (PDA), tablet or laptop computers, smart cards, smart watches, smart key chains, devices with an implantable smart chip, and the like. Hereinafter, such personal mobile electronic devices will be referred to as “mobile devices.” More specific details on such devices and their operations are described in greater detail below.

Examples of the various systems, devices, and equipment operated by a casino in conjunction with an electronic gaming device include bank note or bill acceptor/validators (or “bill validators”), gaming ticket receivers/printers, kiosks at which a user may obtain gaming credit (hereinafter, “credit”) or funds for wagering, routers, and antennas to provide wireless communications (such as Wi-Fi®, Bluetooth, radio frequency identification technologies, near field communication technologies, or other technologies), internet connection servers and systems, casino accounting services, and other systems and equipment. Such systems, devices, and equipment may be based in hardware or software. Such systems, devices, and equipment may be implemented, either in hardware or software, to provide secure transactions with the mobile device. Specific devices, methods, and systems operated by the casino are described in greater detail below.

The systems, methods, and devices described herein make use of a set of similar—but not necessarily identical—components. As used herein, the term “system” can also be used to refer to subsystems that may be used within other systems. As used herein, “component” will refer to a system, whether implemented in hardware or software, a subsystem, a device performing a certain operation, or a method of operation. Operations performed by the systems, methods, and devices may be performed using one or more processing units.

As used herein, a “processing unit” will refer to any of a processor, microprocessor, microcontroller, application specific integrated circuit and related circuitry, or other operational elements as would be known to one skilled in the art. Also encompassed by the term “component” are digital and analog communication elements, circuits, or devices, such as may be operable to send and/or receive signals or messages over a variety of communication channels. Such channels include, but are not limited to, fiber optic links, coax or twisted pair cable, other forms of wired connections, wireless connections such as Bluetooth, Wi-Fi®, cellular communication networks, various near field communication links, and the like.

Described below are certain components to be used in subsequent sequence diagrams of the systems, methods, and devices that may be used in various embodiments disclosed herein. It is not implied that all such components are included in each embodiment, nor that the embodiments are limited to these components or devices. Less commonly used components may be described in relation to particular subsequent Figures. Similarly named components in the Figures may be similar in structure and/or operation, but may have differences; it is not implied they are identical devices.

Another such component may be a Peripheral System. A Peripheral System is a service or system that may work with or within a casino network (such as the casino management system (CMS) described below). The Peripheral System may assist and/or interface between various peripheral components of a CMS, such as the components described herein.

Another such component may be the Peripheral Network Adapter (PNA). The PNA may connect to one or more peripheral components and a network (e.g., CMS) allowing those peripherals to be part of the system and enable certain operations. Such components include the components described herein. Alternatively, the PNA may be a component within any of the components described herein. The PNA can be two separate devices, such as a Wireless Interface and a PNA or a single device that integrates the functionality of both the wireless interface and the PNA. While the PNA may be its own device, it may also be part of another component such as a bill validator, ticket printer, player interface device, etc.

Another such component may be a Casino Management System (CMS). A CMS may be a network service or system used within a casino to link some or all of the components listed above.

Other components may be described in the descriptions of the following Figures.

Applicant incorporates by reference for all purposes U.S. Pat. Nos. 10,140,817, 10,621,825, 10,643,194 and 10,970,967 owned by Applicant or its sister company or affiliate and which detail Applicant's peripheral management system known as FUZION®.

The embodiments of the present invention are configured to enable multicurrency validation on legacy EGMs using a smart bill validator connected to a peripheral management system. Consequently, the EGM software does not need to be modified and can work with any system with access to a TITO system with all secondary currencies being converted to TITO and accepted as TITO.

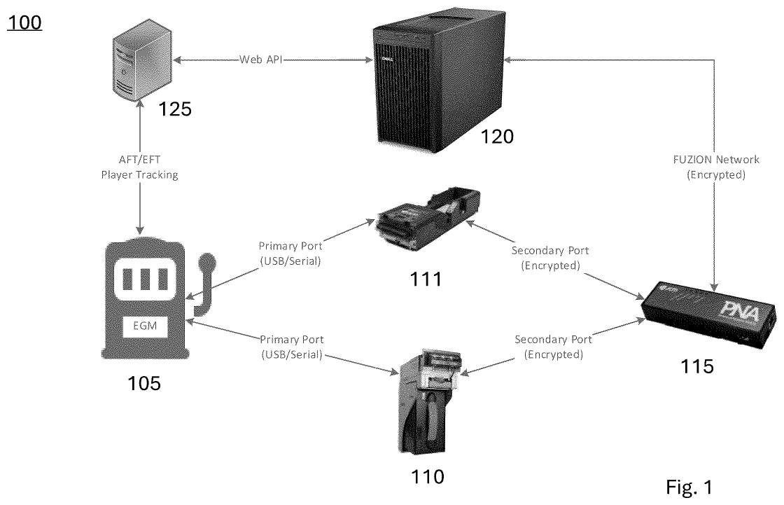

FIG. 1 shows a system architecture 100 comprising an EGM 105, bill validator 110, printer 111, PNA 115, peripheral management system 120, and 3^{rd} party system 125. In one embodiment, the bill validator is an iVIZION® model manufactured, promoted and sold by Applicant. The iVIZION® bill validator 110 utilizes contact image sensor technology to scan banknotes and tickets to capture full images of both sides of the banknotes and tickets. In one embodiment, an anti-stringing device detects and prevents manipulation or mechanical cheating. Those skilled in the art will recognize that bill validators other than the iVIZION® bill validator may be used to facilitate the embodiments of the present invention.

As shown, the bill validator 110 is communicatively linked with a PNA 115 providing network control over the peripheral devices including the bill validator 110. The PNA serves as a bridge between the bill validator 110 and the peripheral management system 120.

A printer 111 communicates with the PNA 115 to receive ticket templates and settings to print currency exchange vouchers, residual credit vouchers, and promotion coupons. In one embodiment, the printer is a GEN5 model manufactured, promoted and sold by Applicant. Those skilled in the art will recognize that printers other than the GEN5 printer may be used to facilitate the embodiments of the present invention.

In one embodiment, the peripheral management system 120 is the FUZION® system manufactured, promoted and sold by Applicant. The FUZION® system is a live monitoring and management system for peripherals (e.g., bill validators 110 and printers 111) associated with the EGMs. Those skilled in the art will recognize that peripheral management systems other than the FUZION® system may be used to facilitate the embodiments of the present invention.

In one embodiment, the 3^{rd} party system 125 is a TITO management system. The TITO management system or other 3^{rd} party system 125 is configured to create, validate, and redeem TITO validation numbers or add credits/points to the EGM 105 using AFT, EFT or a player tracking system.

In one embodiment, the peripheral management system 120 is connected to the 3^{rd} party system (client) 125 using a representational state transfer application programming interface (Web API) to receive transaction information of secondary currency.

Table 1 below shows the components of various embodiments of the present invention and the respective functionality associated with the components to undertake the methods detailed herein.

TABLE 1

| COMPONENT | FUNCTIONALITY |
|---|---|
| iVIZION ® | Communicate with the PNA to receive settings |
| (Bill | of the multicurrency validation. |
| Validator) | Communicate with the PNA to send secondary |
| | currency data and receive TITO validation |
| | number. |
| | Communicate with the EGM on the primary |
| | port to report secondary currency transaction |
| | as TITO ticket. |
| PNA ® (Peripheral | Communicate with the FUZION system to |
| Network Adapter) | receive multicurrency validation data and |
| | settings. |
| | Communicate with the FUZION system to |
| | send secondary currency code and transaction |
| | information. |
| | Communicate with the iVIZION to send |
| | multicurrency validation settings. |
| | Communicate with the iVIZION to receive |
| | secondary currency data and transaction |
| | information. |
| | Validate the secondary currency data from the |
| | iVIZION and report the currency code to |
| | FUZION. |
| FUZION ® | Communicate with the PNA devices to enable |
| System (peripheral | multicurrency validation and send updated |
| management system) | currency validation data (ex: update |
| | acceptance, update security, add new currency, |
| | etc.) |
| | Communicate with 3^{rd} Party System to send |
| | secondary currency information and receive |
| | TITO validation number. |
| | Forward TITO validation number from the 3^{rd} |
| | Party System to the PNA. |
| 3^{rd} Party | Any systems with the ability to create, |
| System (Client) | validate, and redeem TITO validation number. |
| | Connect to the FUZION system through Web |
| | API to receive secondary currency code. |
| | Connect to the FUZION system through Web |
| | API to send TITO validation number. |

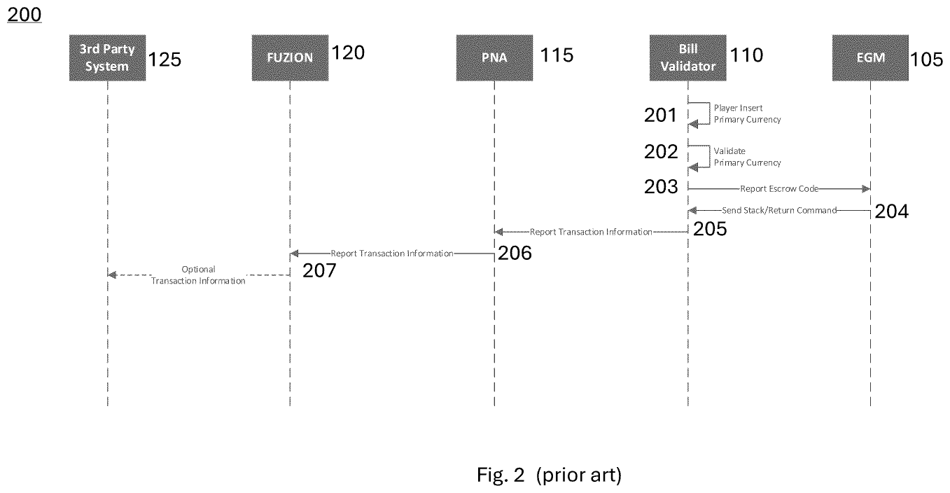

FIG. 2 is a sequence diagram 200 showing a prior art workflow 200 of accepting primary currency supported by the bill validator 110. At 201, a player inserts primary currency into the bill validator 110 associated with the EGM 105. At 202, the bill validator 110 validates the primary currency according to the bill validator's internal programming. At 203, the bill validator 110 reports an escrow code to the EGM 105. At 204, the EGM 105 sends a stack/return command to the bill validator 110. At 205, the bill validator 110 reports the primary currency transaction to the PNA 115. At 206, the PNA 115 reports the primary currency transaction to the peripheral management system 120. At 207, the peripheral management system 120 may report the primary currency transaction to the 3^{rd} party system 125.

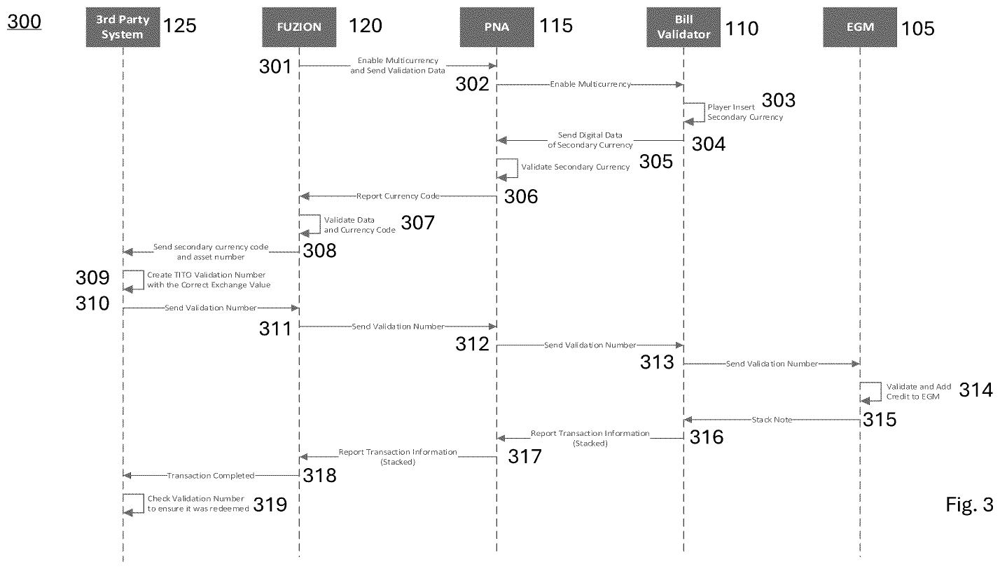

FIG. 3 is a sequence diagram 300 showing a multicurrency workflow 300 with the PNA 115 validating the secondary (i.e., non-primary) currency according to the embodiments of the present invention. At 301, the peripheral management system 120 enables the PNA 115 to validate secondary currency and sends validation codes. At 302, the PNA 115 notifies the bill validator 110 that one or more secondary currencies may be processed. At 303, a player inserts a secondary currency into the bill validator 110 associated with the EGM 105. At 304, the bill validator 110 collects and sends digital data associated with the secondary currency having been inserted therein to the PNA 115. At 305, the PNA 115 validates the secondary currency. At 306, after validating the secondary currency, the PNA 115 reports secondary currency codes to the peripheral management system 120. At 307, the peripheral management system 120 validates the digital data and secondary currency code. At 308, the peripheral management system 120 sends the secondary currency code and EGM identifier to the 3^{rd} party system (e.g., TITO management system). At 309, the 3^{rd} party system 125 creates a TITO validation number using the correct currency exchange value. At 310, the 3^{rd} party system 125 sends the TITO validation number to the peripheral management system 120. At 311, the peripheral management system 120 sends the TITO validation number to the PNA 115. At 312, the PNA 115 sends the TITO validation number to the bill validator 110. At 313, the bill validator 110 sends the TITO validation number to the EGM 105. At 314, the EGM 105 adds credit in an amount corresponding to the TITO validation number is added to the EGM. At 315, the EGM 105 sends the bill validator a stack note commensurate with the TITO validation number. At 316, the bill validator 110 reports the secondary currency transaction to the PNA 115. At 317, the PNA 115 reports the secondary currency transaction to the peripheral management system 120. At 318, the peripheral management system 120 notifies the 3^{rd} party system 125 that the secondary currency transaction is completed. At 319, the 3^{rd} party system 125 confirms that the TITO validation number was redeemed (i.e., credited to the EGM 105).

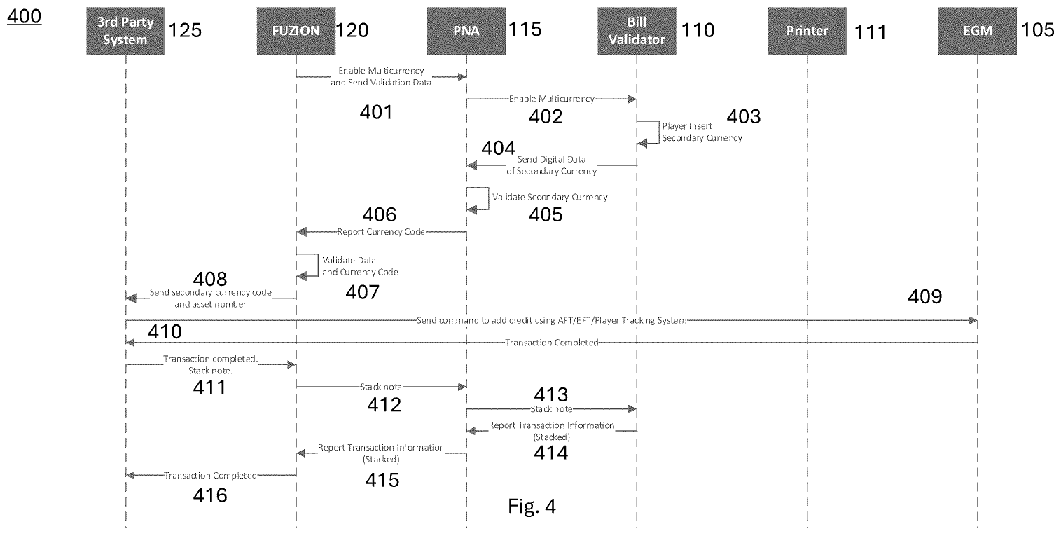

FIG. 4 shows a sequence diagram illustrating multicurrency workflow 400 where the PNA validates a currency, and the 3^{rd} party system directly adds credit to an EGM by utilizing automatic fund transfer (AFT), electronic funds transfer (EFT), or a player tracking system according to the embodiments of the present invention. At 401, the peripheral management system 120 enables the PNA 115 to validate secondary currency and sends validation codes. At 402, the PNA 115 notifies the bill validator 110 that one or more secondary currencies may be processed. At 403, a player inserts a secondary currency into the bill validator 110 associated with the EGM 105. At 404, the bill validator 110 collects and sends digital data associated with the secondary currency having been inserted therein to the PNA 115. At 405, the PNA 115 validates the secondary currency. At 406, after validating the secondary currency, the PNA 115 reports secondary currency codes to the peripheral management system 120. At 407, the peripheral management system 120 validates the digital data and secondary currency codes. At 408, the peripheral management system 120 sends the secondary currency code and EGM identifier to the 3^{rd} party system 125 (e.g., TITO management system). At 409, the 3^{rd} party system 125 sends a command to the EGM 105 to add credits using AFT, EFT or a player tracking system. At 410, the EGM 105 sends the 3^{rd} party system 125 notice that the transaction has been completed. At 411, the 3^{rd} party system 125 sends a stack note to the peripheral management system 120 indicating the transaction has been completed. At 412, the peripheral management system 120 sends a stack note to the PNA 115 indicating the transaction has been completed. At 413, the PNA 115 sends a stack note to the bill validator 110 indicating the transaction has been completed. At 414, the bill validator 110 sends the PNA 115 transaction information and details. At 415, the PNA 115 sends the transaction information and details to the peripheral management system 120. At 416, the peripheral management system sends the 3^{rd} party system 125 transaction information and details.

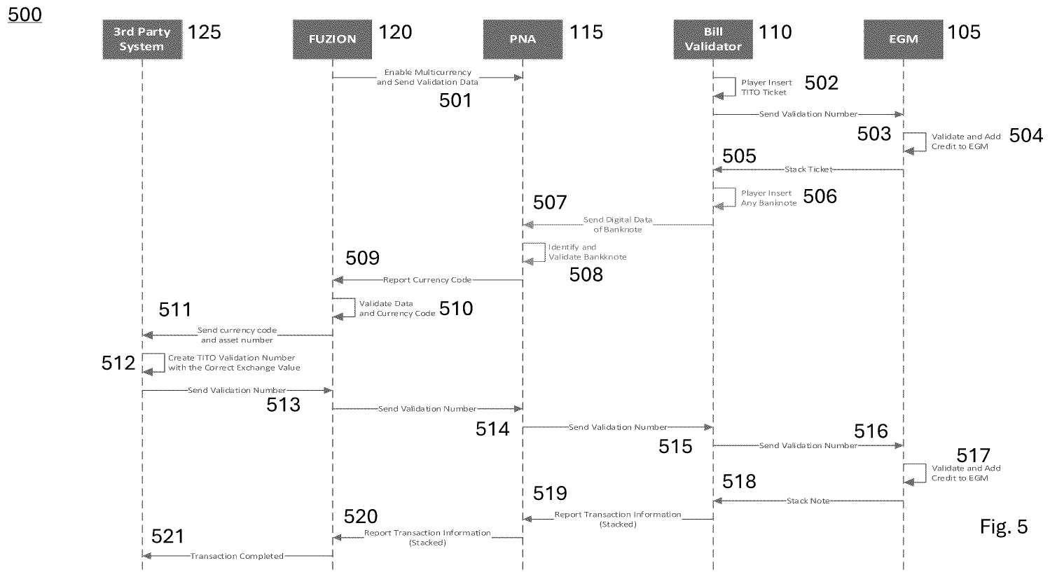

FIG. 5 shows a sequence diagram illustrating multicurrency workflow 500 where the PNA 115 validates a currency, and the 3^{rd} party system 125 directly adds credit to an EGM by utilizing virtual TITO, AFT, EFT, or a player tracking system according to the embodiments of the present invention. In this embodiment, the bill validator 110 contains firmware that offloads the identification and validation of all currencies to the PNA 115. The bill validator 110 firmware only recognizes a TITO ticket or TITO ticket validation number. Such an embodiment permits currency validation updates to be quickly deployed using the peripheral management system 120. Accordingly, the bill validator 110 firmware does not need an update to recognize a new banknote since the 3^{rd} party system 125 can exchange/convert the currency to a virtual TITO ticket or transfer credits directly to the EGM 105 using virtual TITO, AFT, EFT, or a player tracking system.

At 501, the peripheral management system 120 enables the PNA 115 to validate secondary currency and sends validation codes. At 502, a player inserts a TITO ticket into the bill validator 110. At 503, the bill validator 110 sends a TITO ticket validation number to the EGM 105. At 504, the EGM 105 adds credits consistent with the TITO ticket inserted into the bill validator 110 at 502. At 505, the EGM 105 sends a stack ticket to the bill validator 110. At 506, a player inserts a banknote into the bill validator 110. At 507, the bill validator 110 sends digital data of the banknote to the PNA 115. At 508, the PNA 115 identifies and validates the banknote. At 509, the PNA 115 transmits the currency code associated with the banknote to the peripheral management system 120. At 510, the peripheral management system 120 validates the digital data and currency code. At 511, the peripheral management system 120 sends the 3^{rd} party system 125 the currency code and EGM 105 identifier (e.g., serial number). At 512, the 3^{rd} party system 125 creates a TITO ticket validation number using the correct exchange rate. At 513, the 3^{rd} party system 125 sends the TITO ticket validation number to the peripheral management system 120. At 514, the peripheral management system 120 sends the TITO ticket validation number to the PNA 115. At 515, the PNA 115 sends the TITO ticket validation number to the bill validator 110. At 516, the bill validator 110 sends the TITO ticket validation number to the EGM 105. At 517, the EGM 105 validates the TITO ticket validation number and credits the EGM 105 accordingly. At 518, the EGM 105 sends a stack note regarding the transaction to the bill validator 110. At 519, the bill validator 110 sends a stack note regarding the transaction to the PNA 115. At 520, the PNA 115 sends a stack note regarding the transaction to the peripheral management system 120. At 521, the peripheral management system 120 sends a transaction concluded report to the 3^{rd} party system 125.

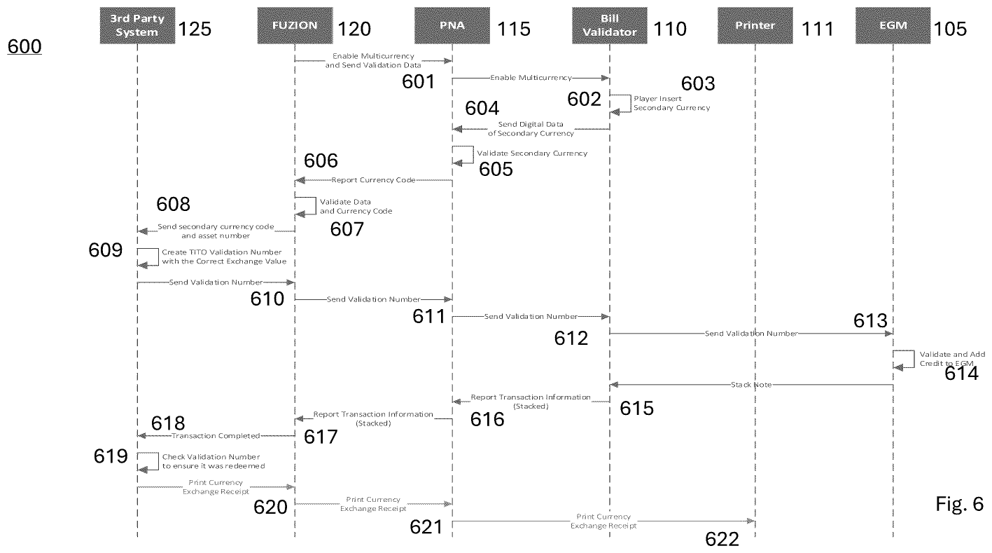

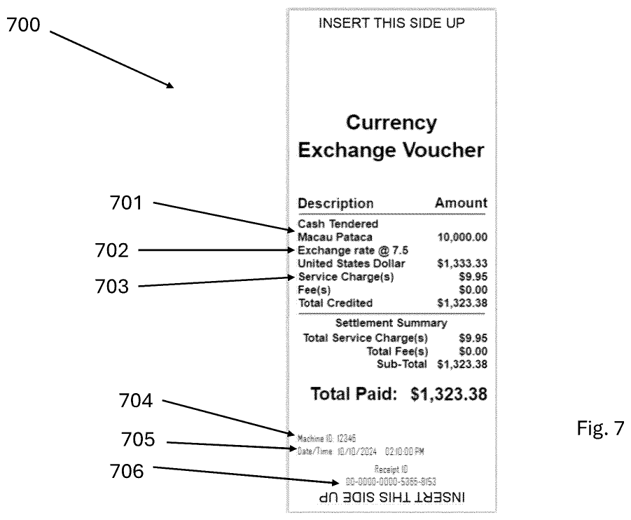

FIG. 6 shows a sequence diagram illustrating multicurrency workflow 600 where the 3^{rd} party system 125 issues a peripheral management system 120 a print command to a specific EGM 105 at any time according to the embodiments of the present invention. At 601, the peripheral management system 120 enables the PNA 115 to validate secondary currency and sends validation codes. At 602, the PNA 115 enables the bill validator 110 to process multicurrency. At 603, the player inserts a secondary currency into the bill validator 110 of the EGM 105. At 604, the bill validator 110 sends digital data of the banknote to the PNA 115. At 605, the PNA 115 identifies and validates the currency. At 606, the PNA 115 transmits the currency code associated with the currency to the peripheral management system 120. At 607, the peripheral management system 120 validates the digital data and currency code. At 608, the peripheral management system 120 sends the 3^{rd} party system 125 the currency code and EGM 105 identifier (e.g., serial number). At 609, the 3^{rd} party system 125 creates a TITO ticket validation number using the correct exchange rate. At 610, the 3^{rd} party system 125 sends the TITO ticket validation number to the peripheral management system 120. At 611, the peripheral management system 120 sends the TITO ticket validation number to the PNA 115. At 612, the PNA 115 sends the TITO ticket validation number to the bill validator 110. At 613, the bill validator 110 sends the TITO ticket validation number to the EGM 105. At 614, the EGM 105 validates the TITO ticket validation number and credits the EGM 105 accordingly. At 615, the EGM 105 sends a stack note regarding the transaction to the bill validator 110. At 616, the bill validator 110 sends a stack note regarding the transaction to the PNA 115. At 617, the PNA 115 sends a stack note regarding the transaction to the peripheral management system 120. At 618, the peripheral management system 120 sends a transaction concluded report to the 3^{rd} party system 125. At 619, the 3^{rd} party system 125 checks the validation number to confirm the virtual TITO ticket was redeemed. At 620, the 3^{rd} party system 125 sends a print command or notice to the peripheral management system 120. At 621, peripheral management system 120 sends the print command or notice to the PNA 115. At 622, PNA 115 sends the print command or notice to the printer 111 which prints the currency exchange receipt (shown in FIG. 7).

FIG. 7 shows an exemplary currency exchange ticket, voucher or receipt 700 according to the embodiments of the present invention. The exemplary currency exchange ticket or voucher 700 depicts an amount of cash tendered and the currency type 701, the associated exchange rate and amount of exchanged money 702, the applicable service charge 703, the identifier of the EGM into which the currency was deposited 704, the date and time of the transaction at the EGM 705 and the receipt ID number 706. Those skilled in the art will recognize that any information desired can be printed on the receipt. In one embodiment, the casino can design the currency exchange receipts using the peripheral management system which interfaces with the printer.

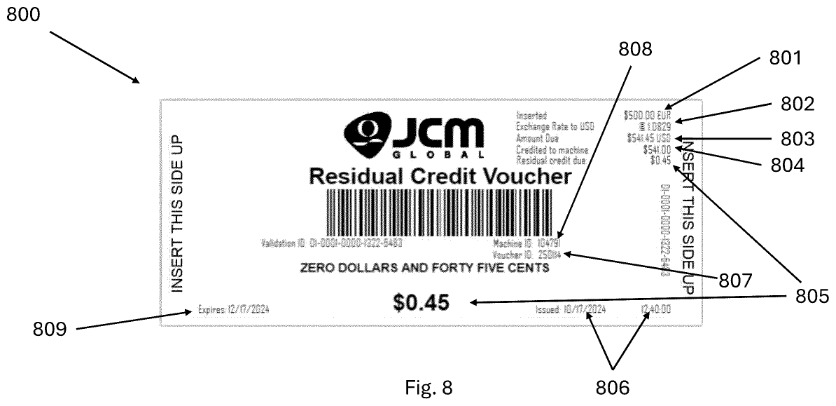

In one embodiment, the 3^{rd} party system can issue a residual credit voucher as a TITO ticket with the remainder balance from the currency exchange that cannot be accepted by an EGM. By way of example, a player may insert a EUR-500 banknote into the bill validator of an EGM configured to accept USD currency only with one credit being equal to $1 in the game. In such an embodiment, the 3^{rd} party system exchanges the EUR-500 banknote into $541.45 USD, but since only $541.00 can be credited onto the EGM, the remaining balance of $0.45 is printed as a residual credit voucher 800 as shown in FIG. 8. Like the currency exchange ticket 700, the residual credit voucher 800 may depict certain information including an amount of cash tendered and the currency type 801, the associated exchange rate 802, the exchanged amount 803, the amount credited to the EGM 804, the residual credit amount 805, the date and time of the transaction at the EGM 806, the receipt ID number 807, the identifier of the EGM into which the currency was deposited 808 and the expiration date of the credit voucher 809.

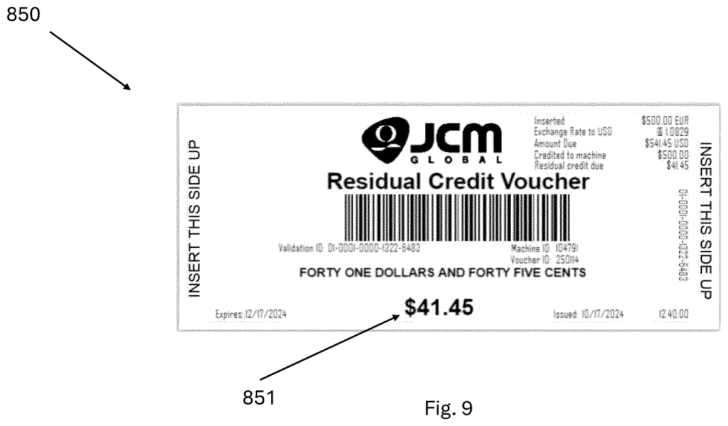

By way of another example using the same deposit as shown in FIG. 8, the EGM or 3^{rd} party system may have a limit of $500.00 per transaction. In this scenario, the 3^{rd} party system generates a virtual TITO ticket of $500.00 in value to be credited onto the EGM and issues a residual credit voucher 850 with a remaining balance of $41.45 as shown in FIG. 9.

Those skilled in the art will recognize that the print residual credit voucher feature can be added to all multicurrency validation workflows detailed herein including conversion to a virtual TITO ticket or directly adding credits to an EGM using AFT, EFT, or a player tracking system.

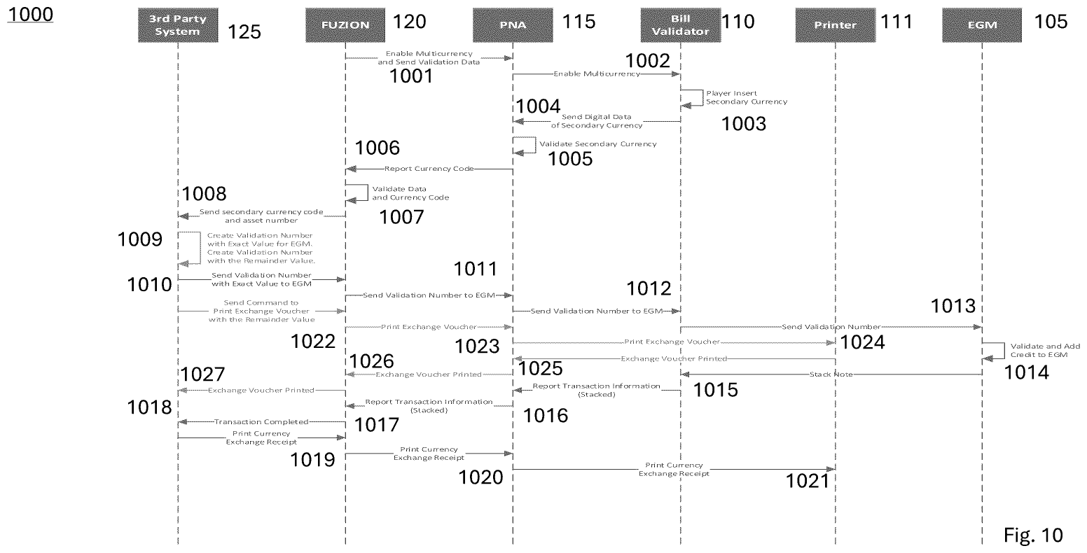

FIG. 10 shows a sequence diagram illustrating a multicurrency workflow 1000 where the residual credit voucher is printed using a separate call to the peripheral management system 120 according to the embodiments of the present invention. At 1001, the peripheral management system 120 enables the PNA 115 to validate secondary currency and sends validation codes. At 1002, the PNA 115 enables the bill validator 110 to process multicurrency. At 1003, the player inserts a secondary currency into the bill validator 110 of the EGM 105. At 1004, the bill validator 110 sends digital data of the banknote to the PNA 115. At 1005, the PNA 115 identifies and validates the currency. At 1006, the PNA 115 transmits the currency code associated with the currency to the peripheral management system 120. At 1007, the peripheral management system 120 validates the digital data and currency code. At 1008, the peripheral management system 120 sends the 3^{rd} party system 125 the currency code and EGM 105 identifier (e.g., serial number). At 1009, the 3^{rd} party system 125 creates a TITO ticket validation number using the correct exchange rate with an exact value for the EGM 105 and creates a TITO ticket validation number for the remainder value. At 1010, the 3^{rd} party system 125 sends the TITO ticket validation number with exact value to the peripheral management system 120. At 1011, the peripheral management system 120 sends the TITO ticket validation number with exact value to the PNA 115. At 1012, the PNA 115 sends the TITO ticket validation number with exact value to the bill validator 110. At 1013, the bill validator 110 sends the TITO ticket validation number with exact value to the EGM 105. At 1014, the EGM 105 validates the TITO ticket validation number and credits the EGM 105 accordingly. At 1015, the EGM 105 sends a stack note regarding the transaction to the bill validator 110. At 1016, the bill validator 110 sends a stack note regarding the transaction to the PNA 115. At 1017, the PNA 115 sends a stack note regarding the transaction to the peripheral management system 120. At 1018, the peripheral management system 120 sends a transaction concluded report to the 3^{rd} party system 125. At 1019, the 3^{rd} party system 125 sends a command or notice to print a currency exchange receipt to the peripheral management system 120. At 1020, the peripheral management system 120 sends the print command or notice to the PNA 115. At 1021, the PNA 115 sends the print command or notice to the printer 111 which prints the currency exchange receipt.

Continuing with the workflow 1000, at 1022, the 3^{rd} party system 125 sends a command to print an exchange voucher with the remainder value to the peripheral management system 120. At 1023, the peripheral management system 120 sends the print command to the PNA 115. At 1024, the PNA 115 sends the print command to the printer 111. At 1025, the printer prints the exchange voucher with the remainder value and notifies the PNA 115. At 1026, the PNA 115 sends a notice of printing the exchange voucher to the peripheral management system 120. At 1027, the peripheral management system 120 sends a notice of printing the exchange voucher to the 3^{rd} party system 125. Steps 1010-1021 and 1022-1027 may be accomplished substantially simultaneously or in a staggered fashion.

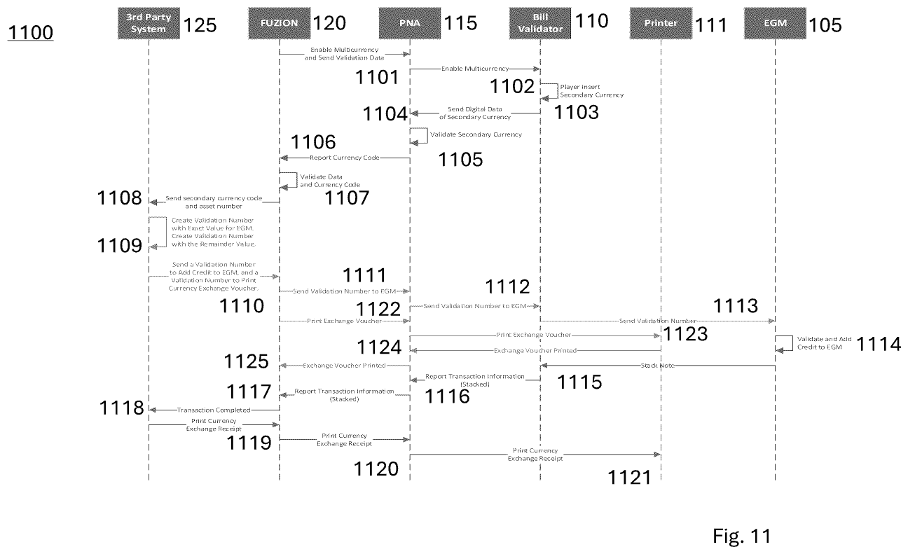

FIG. 11 shows a multicurrency workflow 1100 where credits are added to the EGM and the residual credit voucher is printed using a single call to the peripheral management system according to the embodiments of the present invention. At 1101, the peripheral management system 120 enables the PNA 115 to validate secondary currency and sends validation codes. At 1102, the PNA 115 enables the bill validator 110 to process multicurrency. At 1103, the player inserts a secondary currency into the bill validator 110 of the EGM 105. At 1104, the bill validator 110 sends digital data of the banknote to the PNA 115. At 1105, the PNA 115 identifies and validates the currency. At 1106, the PNA 115 transmits the currency code associated with the currency to the peripheral management system 120. At 1107, the peripheral management system 120 validates the digital data and currency code. At 1108, the peripheral management system 120 sends the 3^{rd} party system 125 the currency code and EGM 105 identifier (e.g., serial number). At 1109, the 3^{rd} party system 125 creates a validation number with exact value for the EGM 105 and validation number to print currency exchange voucher. At 1110, the 3^{rd} party system 125 sends the validation number with exact value for the EGM 105 and validation number to print currency exchange voucher to the peripheral management system 120. At 1111, the peripheral management system 120 sends the validation number with exact value for the EGM 105 to the PNA 115. At 1112, the PNA 115 sends the validation number with exact value for the EGM 105 to the bill validator 110. At 1113, the bill validator 110 sends the validation number with exact value for the EGM 105 to the EGM 105. At 1114, the EGM 105 validates the validation number with exact value for the EGM 105 and add credits to the EGM credit meter. At 1115, the EGM 105 sends a stack note regarding the transaction to the bill validator 110. At 1116, the bill validator 110 sends a stack note regarding the transaction to the PNA 115. At 1117, the PNA 115 sends a stack note regarding the transaction to the peripheral management system 120. At 1118, the peripheral management system 120 sends a transaction concluded report to the 3^{rd} party system 125. At 1119, the 3^{rd} party system 125 sends a command or notice to print a currency exchange receipt to the peripheral management system 120. At 1120, the peripheral management system 120 sends the print command or notice to the PNA 115. At 1121, the PNA 115 sends the print command or notice to the printer 111 which prints the currency exchange receipt.

Continuing with the workflow 1100, at 1022, the 3^{rd} party system 125 sends a command to print an exchange voucher with the remainder value to the peripheral management system 120. At 1122, the peripheral management system 120 sends the print exchange voucher command to the PNA 115. At 1123, the PNA 115 sends the print exchange voucher command to the printer 111. At 1124, the printer prints the exchange voucher with the remainder value and notifies the PNA 115. At 1026, the PNA 115 sends a notice of printing the exchange voucher to the peripheral management system 120. Steps 1110-1114 and 1122-1124 may be accomplished substantially simultaneously or in a staggered fashion.

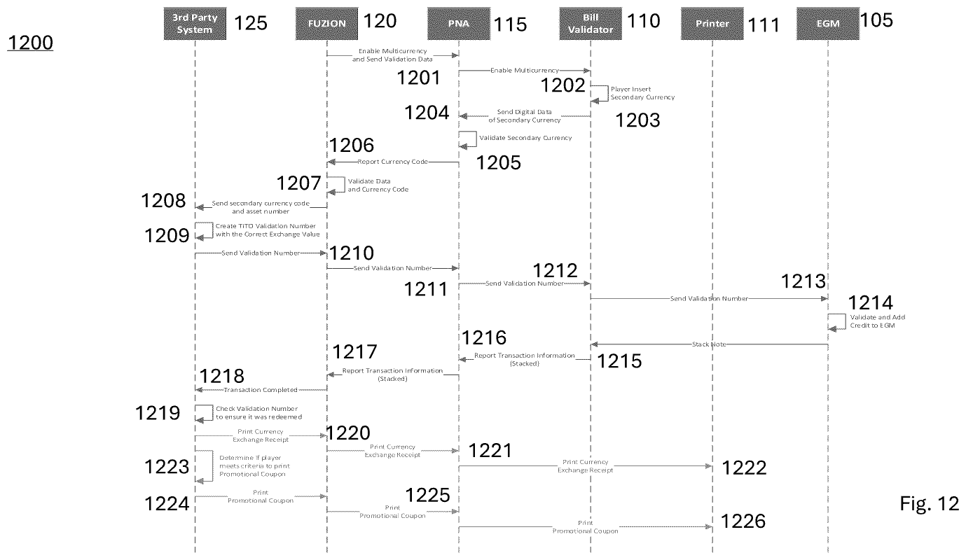

FIG. 12 shows multicurrency workflow 1200 where the 3^{rd} party system 125 issues a promotional coupon for a free drink, free meal, free game play, etc., when a player meets certain criteria according to the embodiments of the present invention. At 1201, the peripheral management system 120 enables the PNA 115 to validate secondary currency and sends validation codes. At 1202, the PNA 115 enables the bill validator 110 to process multicurrency. At 1203, the player inserts a secondary currency into the bill validator 110 of the EGM 105. At 1204, the bill validator 110 sends digital data of the banknote to the PNA 115. At 1205, the PNA 115 identifies and validates the currency. At 1206, the PNA 115 transmits the currency code associated with the currency to the peripheral management system 120. At 1207, the peripheral management system 120 validates the digital data and currency code. At 1208, the peripheral management system 120 sends the 3^{rd} party system 125 the currency code and EGM 105 identifier (e.g., serial number). At 1209, the 3^{rd} party system 125 creates a TITO validation number using the correct currency exchange value. At 1210, the 3^{rd} party system 125 sends the TITO validation number to the peripheral management system 120. At 1211, the peripheral management system 120 sends the TITO validation number to the PNA 115. At 1212, the PNA 115 sends the TITO validation number to the bill validator 110. At 1213, the bill validator 110 sends the TITO validation number to the EGM 105. At 1214, the EGM 105 adds credit in an amount corresponding to the TITO validation number is added to the EGM. At 1215, the EGM 105 sends the bill validator a stack note commensurate with the TITO validation number. At 1216, the bill validator 110 reports the secondary currency transaction to the PNA 115. At 1217, the PNA 115 reports the secondary currency transaction to the peripheral management system 120. At 1218, the peripheral management system 120 notifies the 3^{rd} party system 125 that the secondary currency transaction is completed. At 1219, the 3^{rd} party system 125 confirms that the TITO validation number was redeemed (i.e., credited to the EGM 105).

Continuing with the workflow 1200, at 1220, the 3^{rd} party system 125 sends a command to print a currency exchange receipt to the peripheral management system 120. At 1221, the peripheral management system 120 sends the print currency exchange receipt command to the PNA 115. At 1222, the PNA 115 sends the print currency exchange receipt command to the printer 111 which prints the currency exchange receipt. At 1223, along with the 3^{rd} party system 125 sending a command to print a currency exchange receipt to the peripheral management system 120 at 1220, the 3^{rd} party system 125 determines if the player meets certain criteria to receive a promotional coupon. The criteria may be established by the subject casino and is often based on the player's level of play (e.g., cash in, cash out, theoretical win, theoretical loss, time of play, denomination of play, etc.). If the 3^{rd} party system 125 determines the player is eligible for a promotional coupon, at 1224, the 3^{rd} party system 125 sends a promotional coupon print command to the peripheral management system 120. At 1225, the peripheral management system 120 sends the print command to the PNA 115. At 1226, the PNA 115 sends the print command to the printer 111 which prints the promotional coupon.

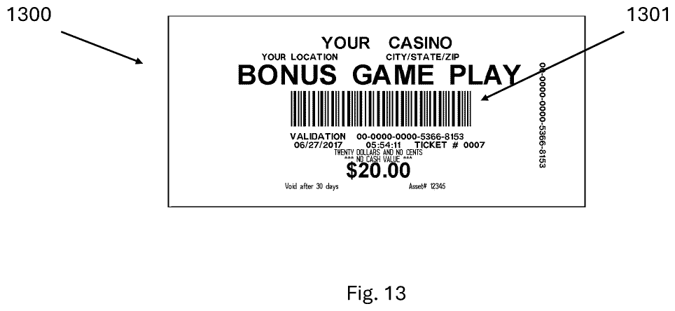

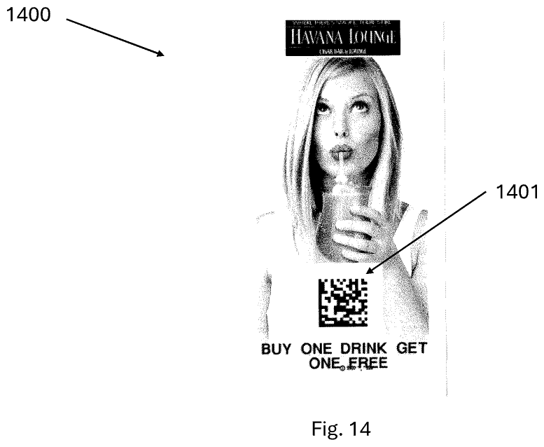

FIGS. 13 and 14 show exemplary promotional coupons of the type the system herein may cause to be printed. Promotional coupon 1300 includes a bar code 1301 while promotional coupon 1400 includes a QR code 1401. The system allows casinos to design their own promotional coupons.

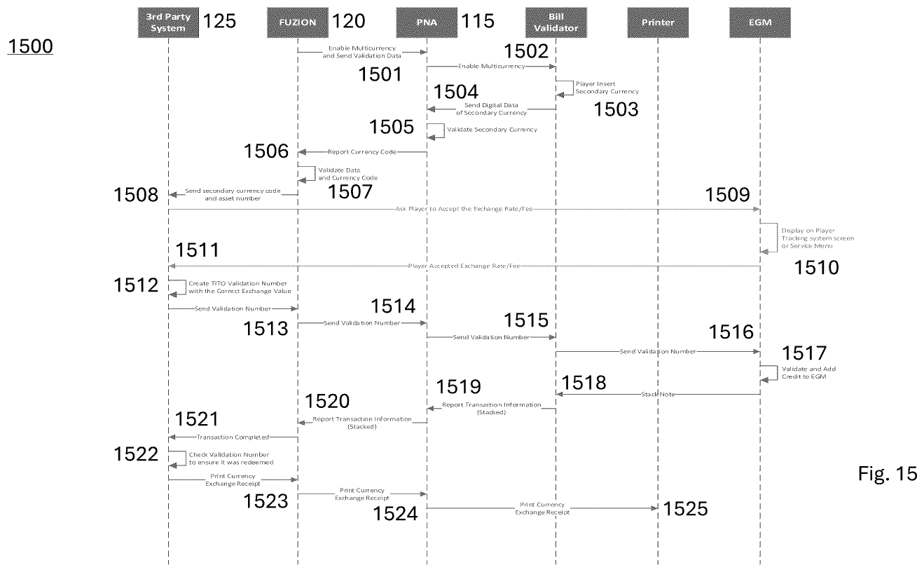

FIG. 15 shows a multicurrency workflow 1500 where player acceptance of the exchange rate and fee on the EGM's display causes the 3^{rd} party system to move forward to the next step of creating a virtual TITO validation number or directly adding credit to an EGM using AFT, EFT, or a player tracking system according to the embodiments of the present invention. At 1501, the peripheral management system 120 enables the PNA 115 to validate secondary currency and sends validation codes. At 1502, the PNA 115 enables the bill validator 110 to process multicurrency. At 1503, the player inserts a secondary currency into the bill validator 110 of the EGM 105. At 1504, the bill validator 110 sends digital data of the banknote to the PNA 115. At 1505, the PNA 115 identifies and validates the currency. At 1506, the PNA 115 transmits the currency code associated with the currency to the peripheral management system 120. At 1507, the peripheral management system 120 validates the digital data and currency code. At 1508, the peripheral management system 120 sends the 3^{rd} party system 125 the currency code and EGM 105 identifier (e.g., serial number). At 1509, the 3^{rd} party system 125 sends a display command to be displayed on the EGM 105 requesting that the player accepts the exchange rate and associated exchange fec. At 1510, the EGM 105 displays the prompt requesting that the player accepts the exchange rate and associated exchange fec. At 1511 the player has accepted the exchange rate and exchange fee which the EGM 105 reports to the 3^{rd} party system 125. At 1512, responsive to the player accepting the exchange rate and exchange fee, the 3^{rd} party system 125 creates a TITO validation number using the correct currency exchange value. At 1513, the 3^{rd} party system 125 sends the TITO validation number to the peripheral management system 120. At 1514, the peripheral management system 120 sends the TITO validation number to the PNA 115. At 1515, the PNA 115 sends the TITO validation number to the bill validator 110. At 1516, the bill validator 110 sends the TITO validation number to the EGM 105. At 1517, the EGM 105 adds credit in an amount corresponding to the TITO validation number is added to the EGM. At 1518, the EGM 105 sends the bill validator a stack note commensurate with the TITO validation number. At 1519, the bill validator 110 reports the secondary currency transaction to the PNA 115. At 1520, the PNA 115 reports the secondary currency transaction to the peripheral management system 120. At 1521, the peripheral management system 120 notifies the 3^{rd} party system 125 that the secondary currency transaction is completed. At 1522, the 3^{rd} party system 125 confirms that the TITO validation number was redeemed (i.e., credited to the EGM 105). At 1523, the 3^{rd} party system 125 sends a print currency exchange receipt command to the peripheral management system 120. At 1524, the peripheral management system 120 sends the print command to the PNA 115. At 1525, the PNA 115 sends the print command to the printer 111 which prints the currency exchange receipt.

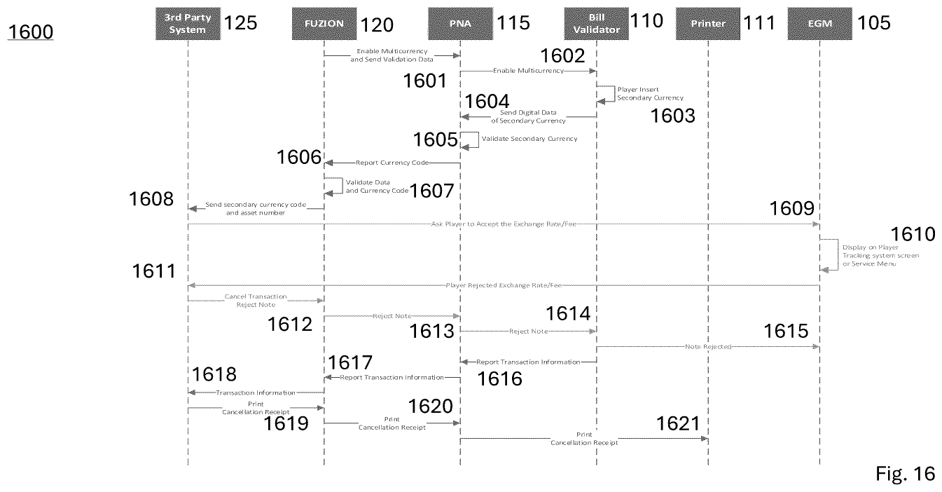

FIG. 16 shows a multicurrency workflow 1600 where the player rejects the exchange rate and/or fee on the EGM's display causing the 3^{rd} party system 125 to instruct the peripheral management system 120 to reject/return the banknote back to the player according to the embodiments of the present invention. At 1601, the peripheral management system 120 enables the PNA 115 to validate secondary currency and sends validation codes. At 1602, the PNA 115 enables the bill validator 110 to process multicurrency. At 1603, the player inserts a secondary currency into the bill validator 110 of the EGM 105. At 1604, the bill validator 110 sends digital data of the banknote to the PNA 115. At 1605, the PNA 115 identifies and validates the currency. At 1606, the PNA 115 transmits the currency code associated with the currency to the peripheral management system 120. At 1607, the peripheral management system 120 validates the digital data and currency code. At 1608, the peripheral management system 120 sends the 3^{rd} party system 125 the currency code and EGM 105 identifier (e.g., serial number). At 1609, the 3^{rd} party system 125 sends a display command to be displayed on the EGM 105 requesting that the player accepts the exchange rate and associated exchange fec. At 1610, the EGM 105 displays the prompt requesting that the player accepts the exchange rate and associated exchange fec. At 1611 the player has rejected the exchange rate and/or exchange fee which the EGM 105 reports to the 3^{rd} party system 125. At 1612, responsive to the player rejecting the exchange rate and exchange fcc, the 3^{rd} party system 125 cancels the transaction and sends a reject banknote command to the peripheral management system 120. At 1613, the peripheral management system 120 sends the reject banknote command to the PNA 115. At 1614, the PNA 115 sends the reject banknote command to the bill validator 110. At 1615, the bill validator 110 rejects the banknote and returns the banknote to the player and the sends a notification to the EGM 105. At 1616, the bill validator 110 sends a banknote rejection notification to the PNA 115. At 1617, the PNA 115 sends a banknote rejection notification to the peripheral management system 120. At 1618, the peripheral management system 120 sends the banknote rejection notice to the 3^{rd} party system 125. At 1619, the 3^{rd} party system 125 sends a print cancellation receipt command to the peripheral management system 120. At 1620, the peripheral management system 120 sends a print cancellation receipt command to the PNA 115. At 1621, the PNA 115 sends a print cancellation receipt command to the printer 111 which prints the cancellation receipt.

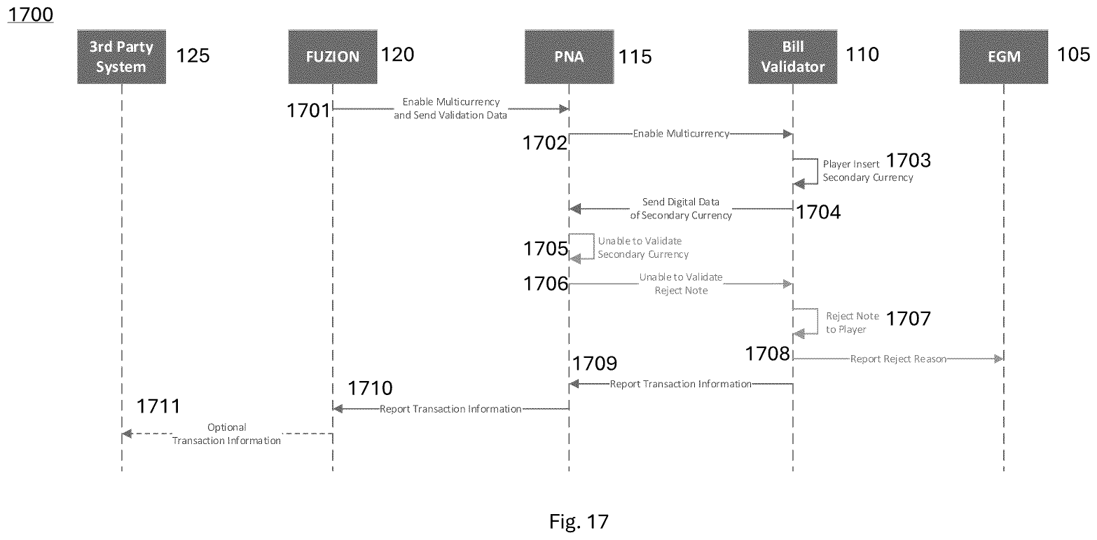

FIG. 17 is a sequence diagram 1700 illustrating the PNA 115 being unable to validate the secondary currency and instructing the bill validator 110 to reject the note. At 1701, the peripheral management system 120 enables the PNA 115 to validate secondary currency and sends validation codes. At 1702, the PNA 115 notifies the bill validator 110 that one or more secondary currencies may be processed. At 1703, a player inserts a secondary currency into the bill validator 110 associated with the EGM 105. At 1704, the bill validator 110 collects and sends digital data associated with the secondary currency having been inserted therein. At 1705, the PNA 115 is unable to validate the secondary currency. At 1706, after failing to validate the secondary currency, the PNA 115 reports to the bill validator 110 that the secondary currency cannot be validated. At 1707, the bill validator 110 rejects the secondary currency back to the player. At 1708, the bill validator 110 notifies the EGM 105 of the reason for rejecting the secondary currency. At 1709, the bill validator 110 reports the transaction information to the PNA 115. At 1710, the PNA 115 reports the transaction information to the peripheral management system 120. At 1711, the peripheral management system 120 reports the transaction information to the 3^{rd} party system 125.

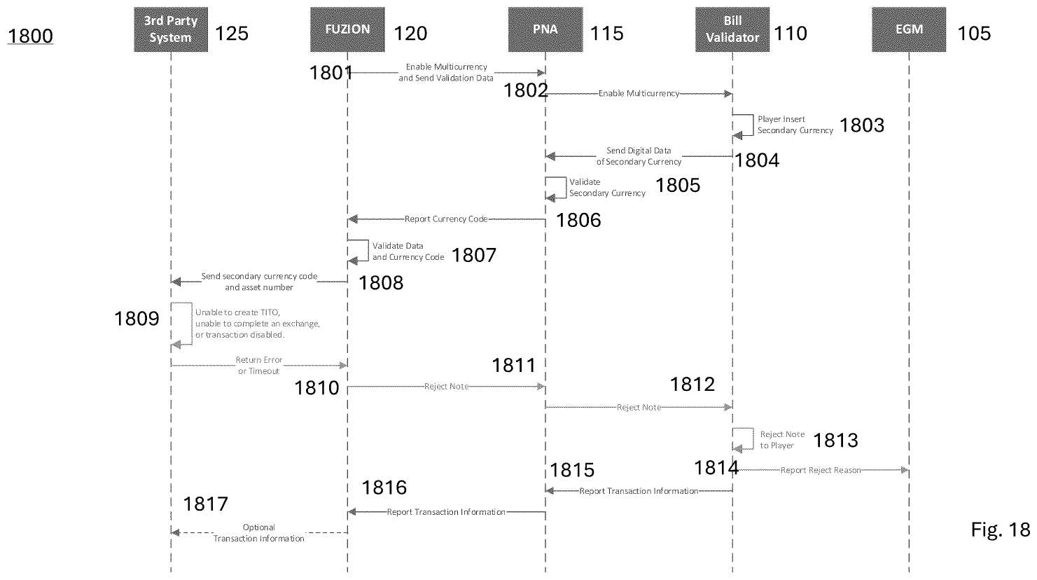

FIG. 18 is a sequence diagram 1800 illustrating the 3^{rd} party system 125 being unable to create a TITO validation number or complete an exchange, or a secondary currency transaction is disabled. At 1801, the peripheral management system 120 enables the PNA 115 to validate secondary currency and sends validation codes. At 1802, the PNA 115 notifies the bill validator 110 that one or more secondary currencies may be processed. At 1803, a player inserts a secondary currency into the bill validator 110 associated with the EGM 105. At 1804, the bill validator 110 collects and sends digital data associated with the secondary currency having been inserted therein. At 1805, the PNA 115 validates the secondary currency. At 1806, after validating the secondary currency, the PNA 115 reports secondary currency codes to the peripheral management system 120. At 1807, the peripheral management system 120 validates the digital data and secondary currency code. At 1808, the peripheral management system 120 sends the secondary currency code and EGM identifier to the 3^{rd} party system (e.g., TITO management system). At 1809, the 3^{rd} party system 125 is unable to create a TITO validation number or complete a currency exchange or the transaction is disabled. At 1810, the 3^{rd} party system 125 notifies the peripheral management system 120 of the error or causes a timeout. At 1811, the peripheral management system 120 transmits a reject note to the PNA 115. At 1812, the PNA 115 transmits a reject note to the bill validator 110. At 1813, the bill validator 110 rejects the secondary currency back to the player. At 1814, the bill validator 110 notifies the EGM 105 of the reason for rejecting the secondary currency. At 1815, the bill validator 110 reports the transaction information to the PNA 115. At 1816, the PNA 115 reports the transaction information to the peripheral management system 120. At 1817, the peripheral management system 120 reports the transaction information to the 3^{rd} party system 125.

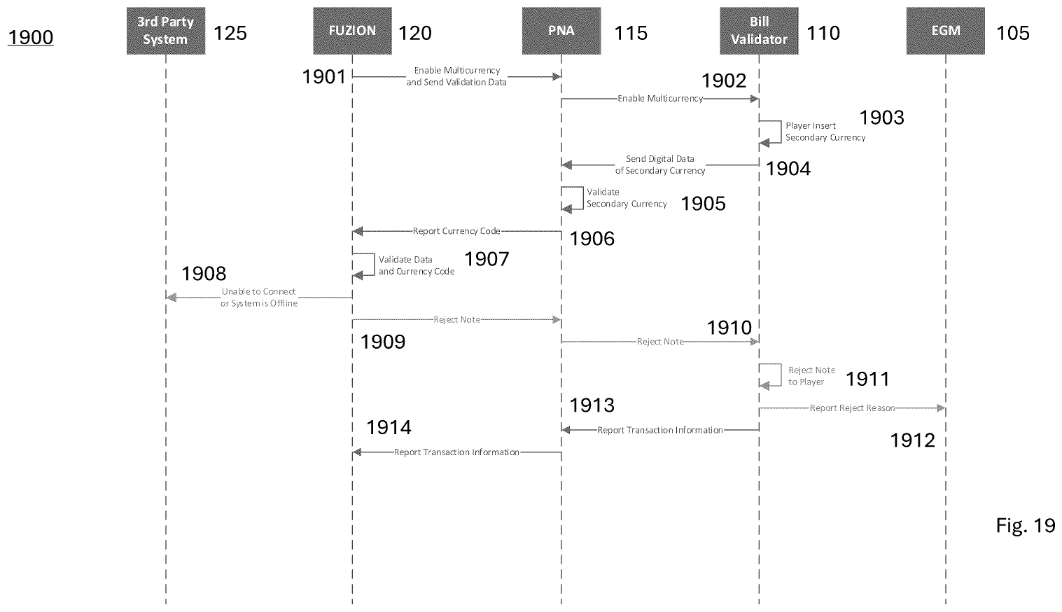

FIG. 19 is a sequence diagram 1900 illustrating the 3^{rd} party system 125 being offline or not connected to the peripheral management system 120 according to the embodiments of the present invention. At 1901, the peripheral management system 120 enables the PNA 115 to validate secondary currency and sends validation codes. At 1902, the PNA 115 notifies the bill validator 110 that one or more secondary currencies may be processed. At 1903, a player inserts a secondary currency into the bill validator 110 associated with the EGM 105. At 1904, the bill validator 110 collects and sends digital data associated with the secondary currency having been inserted therein. At 1905, the PNA 115 validates the secondary currency. At 1906, after validating the secondary currency, the PNA 115 reports secondary currency codes to the peripheral management system 120. At 1907, the peripheral management system 120 validates the digital data and secondary currency code. At 1908, the peripheral management system 120 is unable to connect to the 3^{rd} party system 125. At 1909, the peripheral management system 120 transmits a reject note to the PNA 115. At 1910, the PNA 115 transmits a reject note to the bill validator 110. At 1911, the bill validator 110 rejects the secondary currency back to the player. At 1912, the bill validator 110 notifies the EGM 105 of the reason for rejecting the secondary currency. At 1913, the bill validator 110 reports the transaction information to the PNA 115. At 1914, the PNA 115 reports the transaction information to the peripheral management system 120.

Other examples and implementations are within the scope and spirit of the disclosure and appended claims. For example, features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

The foregoing description, for purposes of explanation, used specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

Although the invention has been described in detail with reference to several embodiments, additional variations and modifications exist within the scope and spirit of the invention as described and defined in the following claims.

We claim:

1. A casino system comprising:
an electronic gaming machine including a bill validator in communication with a peripheral network adapter, said peripheral network adapter in communication with a peripheral management system, and said peripheral management system in communication with a 3^{rd} party system;
said bill validator configured to validate one or more primary currencies and, responsive to insertion of a secondary currency, trigger a secondary currency exchange procedure by causing secondary currency data to be sent to said 3^{rd} party system;
upon receipt of said secondary currency data, said 3^{rd} party system configured to determine an exchange value for said secondary currency into said one or more primary currencies based on an exchange rate, generate a TITO validation number, and cause said TITO validation number to be sent to said electronic gaming machine; and
wherein, upon receipt of said TITO validation number, said electronic gaming machine adds gaming credits to a credit meter based on said exchange value.

2. The casino system of claim 1 further comprising a printer in communication with said electronic gaming machine.

3. The casino system of claim 2 further comprising said printer in communication with said peripheral network adapter.

4. The casino system of claim 1 wherein said secondary currency data includes a currency code.

5. The casino system of claim 1 wherein said peripheral management system is configured to send an electronic gaming machine identifier to said 3^{rd} party system.

6. The casino system of claim 1 wherein said 3^{rd} party system is configured to confirm redemption of said TITO validation number by said electronic gaming machine.

7. The casino system of claim 1 wherein said 3^{rd} party system is a TITO system.

8. The casino system of claim 1 wherein said bill validator sends said secondary currency data to said peripheral network adapter which sends said secondary currency data to said peripheral management system which sends said secondary currency data to said 3^{rd} party system.

9. The casino system of claim 1 wherein said 3^{rd} party system sends said TITO validation number to said peripheral management system which sends said TITO validation number to said peripheral network adapter which sends said TITO validation number to said bill validator which sends said TITO validation number to said electronic gaming machine.

10. A casino system comprising:
an electronic gaming machine in communication with a bill validator;
a peripheral network adapter in communication with said bill validator and a peripheral management system;
a 3^{rd} party system in communication with said peripheral management system;
said bill validator configured to validate one or more primary currencies, send secondary currency data to said peripheral network adapter and send a TITO validation number representing a secondary currency transaction to said electronic gaming machine;
said peripheral network adapter configured to validate said secondary currency data, send said secondary currency data to said peripheral management system, send multicurrency validation settings and said TITO validation number to said bill validator;
said peripheral management system configured to enable multicurrency validation on said peripheral network adapter, send said secondary currency data to said 3^{rd} party system, and send said TITO validation number to said peripheral network adapter;
said 3^{rd} party system configured to generate said TITO validation number, determine an exchange value for said secondary currency into said one or more primary currencies based on an exchange rate, and send said TITO validation number to said peripheral management system; and
wherein, upon receiving said TITO validation number, said electronic gaming machine adds gaming credits to a credit meter based on said exchange value.

11. The casino system of claim 10 further comprising a printer in communication with said electronic gaming machine.

12. The casino system of claim 11 further comprising said printer in communication with said peripheral network adapter.

13. The casino system of claim 10 wherein said secondary currency data includes a currency code.

14. The casino system of claim 10 wherein said peripheral management system is further configured to send an electronic gaming machine identifier to said 3^{rd} party system.

15. The casino system of claim 10 wherein said 3^{rd} party system is further configured to confirm redemption of said TITO validation number by said electronic gaming machine.

16. The casino system of claim 10 wherein said 3^{rd} party system is a TITO system.

17. A casino method utilizing an electronic gaming machine including a bill validator in communication with a peripheral network adapter, said peripheral network adapter in communication with a peripheral management system, and said peripheral management system in communication with a 3^{rd} party system, comprising:
configuring said bill validator to validate one or more primary currencies and cause secondary currency data, responsive to insertion of a secondary currency, to be sent to said 3^{rd} party system;
configuring said 3^{rd} party system, upon receipt of said secondary currency data, to determine an exchange value for said secondary currency into said one or more primary currencies based on an exchange rate, generate a TITO validation number, and cause said TITO validation number to be sent to said electronic gaming machine; and
causing, upon receipt of said TITO validation number, said electronic gaming machine to add gaming credits to a credit meter based on said exchange value.

18. The casino method of claim 17 wherein said secondary currency data includes a currency code.

19. The casino method of claim 17 further comprising configuring said peripheral management system to send an electronic gaming machine identifier to said 3^{rd} party system.

20. The casino method of claim 17 further comprising configuring said 3^{rd} party system to confirm redemption of said TITO validation number by said electronic gaming machine.

21. The casino method of claim 17 wherein said 3^{rd} party system is a TITO system.

22. A casino method comprising:
communicatively linking an electronic gaming machine with a bill validator;
communicatively linking a peripheral network adapter with said bill validator and a peripheral management system;
communicatively linking a 3^{rd} party system with said peripheral management system;
configuring said bill validator to validate one or more primary currencies, send secondary currency data to said peripheral network adapter and send a TITO validation number representing a secondary currency transaction to said electronic gaming machine;
configuring said peripheral network adapter to validate said secondary currency data, send said secondary currency data to said peripheral management system, send multicurrency validation settings and said TITO validation number to said bill validator;
configuring said peripheral management system to enable multicurrency validation on said peripheral network adapter, send said secondary currency data to said 3^{rd} party system, and send said TITO validation number to said peripheral network adapter;
configuring said 3^{rd} party system to generate said TITO validation number, determine an exchange value for said secondary currency into said one or more primary currencies based on an exchange rate, and send said TITO validation number to said peripheral management system; and
adding, upon receiving said TITO validation number, gaming credits to said electronic gaming machine credit meter.
